(19) United States
(12) Patent Application Publication
(10) Pub. No.: US 2013/0213776 A1
(43) Pub. Date: Aug. 22, 2013

(54) TAP CHANGER HAVING A FREEWHEEL

(71) Applicants: Klaus Hoepfl, Maxhuette-Haidhof (DE); Gregor Wilhelm, Regensburg (DE); Silke Wrede, Zeitlarn (DE)

(72) Inventors: Klaus Hoepfl, Maxhuette-Haidhof (DE); Gregor Wilhelm, Regensburg (DE); Silke Wrede, Zeitlarn (DE)

(21) Appl. No.: 13/504,293

(22) PCT Filed: Dec. 11, 2010
(86) PCT No.: PCT/EP10/07563

§ 371 Date: May 11, 2012

(30) Foreign Application Priority Data
Feb. 11, 2010 (DE) 10 2010 007 535.3

(51) Int. Cl. H01H 9/00

(52) U.S. Cl. CPC H01H 9/0027
USPC 200/11 TC

(57) ABSTRACT

The invention relates to a stepping switch (10) for switching among at least two winding taps (12, 14) of a step transformer (16) without interruption, said step transformer having a rotatable switching shaft (22), with which actuating elements (24) for a plurality of actuating phases for mechanical switching elements (MTF, TTF) or vacuum switching tubes (MSV, TTV) are associated.

The present invention relates to a tap changer for uninterrupted switching over between at least two winding taps of a tapped transformer, which comprises a rotatable switching shaft with which actuating elements for a plurality of actuation phases for mechanical switching elements or vacuum switching tubes are associated.

A tap changer is known from DE 20 21 575, that comprises, in total, four vacuum switching tubes per phase. Provided in each of the two load branches that are present are a respective vacuum switching tube as main contact and a respective further vacuum switching tube, in series with a switch-over resistance, as resistance contact.

In the case of uninterrupted load switching-over from the is previous winding tap n to a new, preselected winding tap n+1 initially the main contact of the side being switched off is opened, after which the resistance contact of the side taking over is closed so that a compensating current limited by the switch-over resistances flows between the two taps n and n+1. After the previously closed resistance contact of the side that is switching off has opened, the main contact of the side that is taking over then closes so that the entire load current is conducted from the new winding tap n+1 to the load shunt, whereby the switching-over is concluded.

The vacuum switching tubes, which are used in this known tap changer and numerous similar known forms of embodiment, in place of conventional mechanical contacts for the load switching-over have a number of advantages. Since the contacts themselves are encapsulated in the vacuum, high switching capabilities can be realized. The encapsulated, hermetically sealed contacts cannot, moreover, lead to corrosion and contamination of the insulating oil, which surrounds them, in the tap changer due to contact burning or arcs. In addition, vacuum switching tubes have in the meantime become available as very compact components; they have a low requirement for space and need only relatively small actuating forces.

However, in various cases of use of such known tap changers for vacuum switching tubes for regulation of power transformers a high surge voltage strength up to, preferably, voltages of 100 kV and significantly above that is required. Such undesired surge voltages, the height of which is substantially caused by the construction of the tapped transformer and the winding parts between the individual tap stages, are on the one hand lightning surge voltages resulting from lightning strikes in the mains. On the other hand, switching surge voltages can also occur, these being caused by unpredictable switching surges in the mains to be regulated. If the surge voltage strength of the tapped transformer in insufficient, a transient tap short-circuit or an undesired breakdown at the ceramic or vacuum switching tubes involved in the damping screen can occur in the load branch not conducting the load current, which not only can cause long-term damage thereof, but also is generally undesirable.

In order to combat excessive surge voltage loads it is already known from DE 23 57 209 [U.S. Pat. No. 3,934,174] and DE 26 04 344 to provide protective spark gaps or also voltage-dependent resistances or even both between the load branches; however, in many cases these means are inadequate and cannot exclude or completely exclude harmful surge voltage loads in their action.

An object of the present invention consists in proposing a tap changer of the kind stated in the introduction, with a high surge voltage strength, also termed aO strength.

This object of this invention is achieved with the subject of the independent patent claim. Features of advantageous developments of the invention are evident from the dependent claims. In order to achieve the object of the invention a tap changer for uninterrupted switching over between at least two winding taps of a tapped transformer with the features of the independent claim 1 is proposed. In this tap changer a load branch with at least two parallel paths is provided. Each of these paths can comprise a series arrangement of at least one vacuum switching tube and at least one mechanical switching element, which in the present context can also be termed variably settable or switchable-over switching contact.

Associated with one of the at least two paths can be a resistance arranged in series with the respective vacuum switching tube and the mechanical switching element. In this way the at least two winding taps can be variably coupled together and/or acted on by a load shunt. According to the present invention the total of at least two vacuum switching tubes and at least two mechanical switching elements are connectable in common in respectively different switching directions with a defined offset in time relative to one another. In addition, at least one of the mechanical switching elements has a switching or trigger instant that is delayed in time relative to the remaining switching elements or vacuum switching tubes and independently of the switching direction, whereby specific switching states can be realized in simple, reliable and exactly reproducible manner with the help of mechanical means.

According to a preferred variant of embodiment of the tap changer according to the invention the delayed switching or trigger instant has a defined spacing in time from the remaining switching or trigger instants of the further mechanical switching elements and vacuum switching tubes. In addition, the one mechanical switching element having a switching or trigger instant delayed in time is arranged downstream of all other switching elements and vacuum switching tubes.

The tap changer according to the invention provides a rotatable switching shaft with which actuating elements for each actuation phase for the mechanical switching elements or vacuum switching tubes are associated, wherein associated with the actuating elements are respective cam disks, which are rotatable and concentric with the switching shaft, with end face profiles. These end face profiles can be formed by, in particular, projections, lobes or the like suitable for actuation of the switching elements and/or vacuum switching tubes. In addition, the switching instants triggered by the at least one cam disk corresponding with the mechanical switching element to be switched with a delay in time and are delayed in time relative to the rotational movements of the remaining cam disks or the remaining actuating elements independently of the rotational direction of the at least one cam disk or the rotational direction of the switching shaft.

Moreover, an additional permanent main contact can be provided at the tap changer and/or coupled therewith. A respective mechanical contact (MC) that conducts a permanent current can be additionally present at such a tap changer on the switching-off and/or switching-off side. The contact of such a permanent contact switch preferably opens on the switching-off side ahead of all remaining switching elements (MSV, TTV, MTF, TTF), whereas the contact on the switching-on side closes after all remaining is switching elements.

The switching or triggering, which is delayed in each switching direction, of the at least one mechanical switching element can be realized at the tap changer in that a freewheel element for phase displacement of the switching instant depending on the rotational direction of the switching shaft is associated with the at least one switching means and the cam disk associated therewith. This freewheel can comprise, in particular, a guide gate, which is of circularly segmental shape and arranged concentrically with respect to the switching shaft, for an entrainer of the cam disk as well as a sleeve-like separating element, which is fixed to the housing to be stationary relative to the rotatable switching shaft and cam disks and decouples the rotational movements of the switching shaft and the cam disk, which is mounted thereon, from one another. The separating element ensures in simple and effective manner that the cam disk does not, on rotation of the switching shaft, co-rotate in uncontrolled manner, for example due to viscous effects of the oil bath in which the components of the tap changer are arranged, but that the cam disk is rotated exclusively by the co-operating entrainer elements and guide gates. These co-operating entrainer elements and guide gates define, through the dimensions and arrangements thereof, the hysteresis of the freewheeling, i.e. the switching delay, which in each rotational direction of the switching shaft has a spacing in time of exactly the same amount from the switching start.

The invention is based generally on the idea of being able to realize the desired surge voltage strength or aO strength is by respective rearwardly shifted switching of a mechanical switching element of one of a plurality of load branches independently of the respective switching direction. In this manner, surge voltages that possibly arise do not load the vacuum switching tubes in the respective load branch not conducting load current and thus remain harmless to the vacuum switching tubes.

The invention is explained in more detail in the following on the basis of exemplifying embodiments with use of the drawings described in the following:

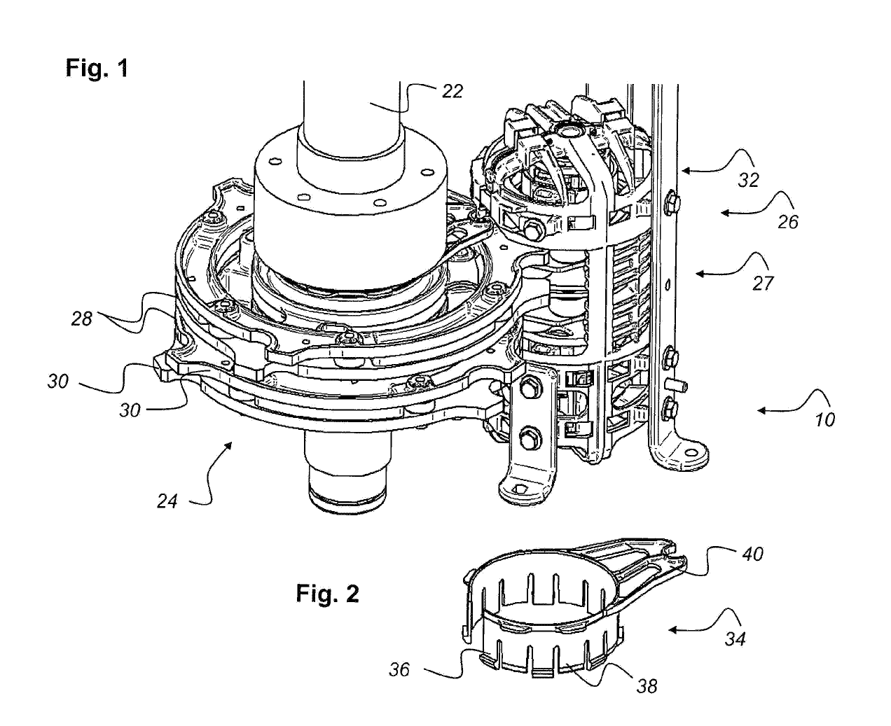

FIG. 1 shows a schematic perspective illustration of a variant of embodiment of a tap changer according to the invention with a freewheel, consisting of a switching shaft with actuating elements arranged thereat and switching elements coupled therewith,

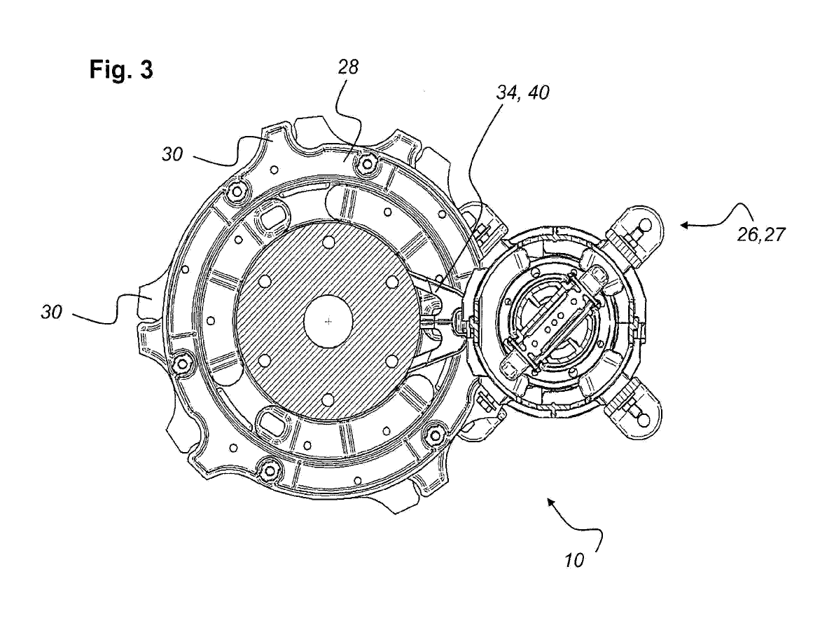

FIG. 2 shows, in a schematic detail illustration, a detail of an actuating mechanism of the tap changer according to FIG. 1,

FIG. 3 shows a schematic inverted plan view of the tap changer according to FIG. 1,

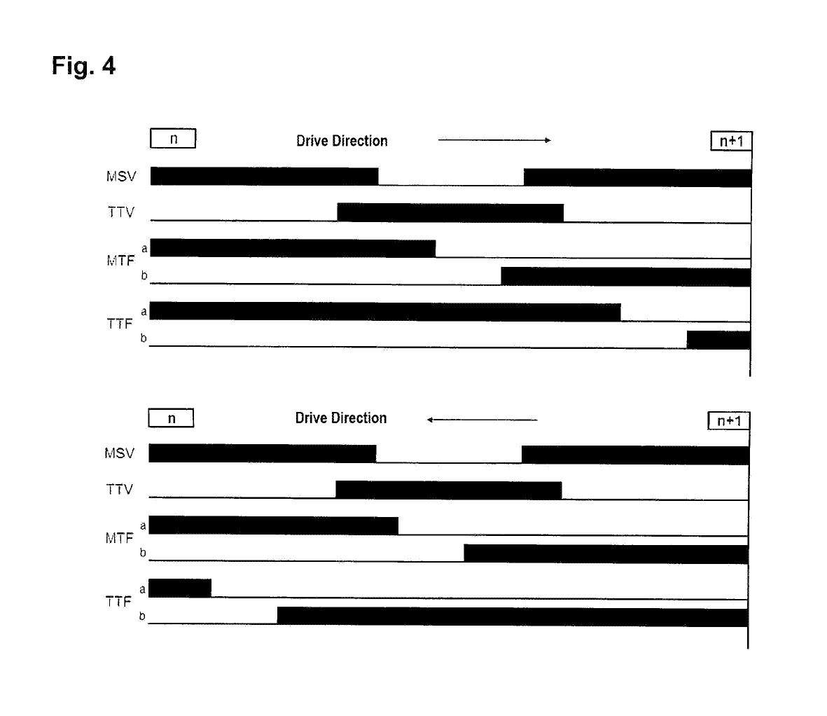

FIG. 4 shows a sequence diagram for clarification of the switching sequences of an embodiment of the tap changer according to the invention in accordance with FIGS. 1 to 3 during a switching cycle, in respectively different switching directions.

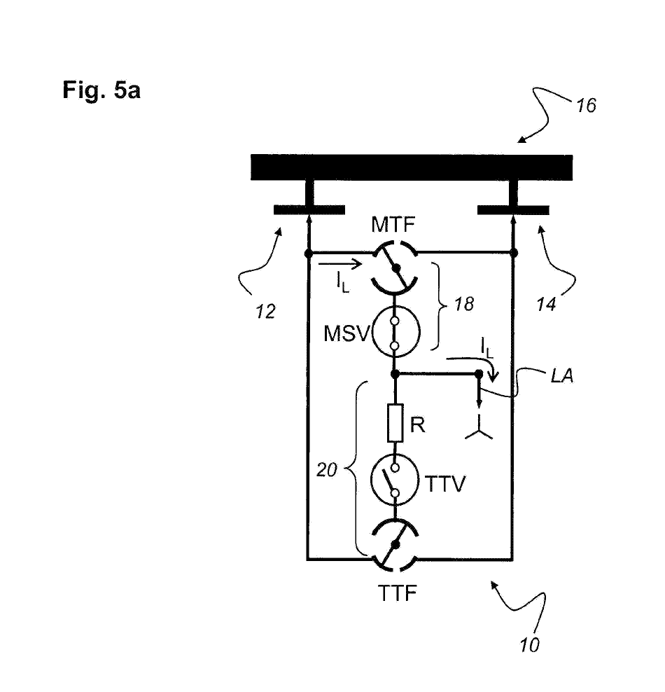

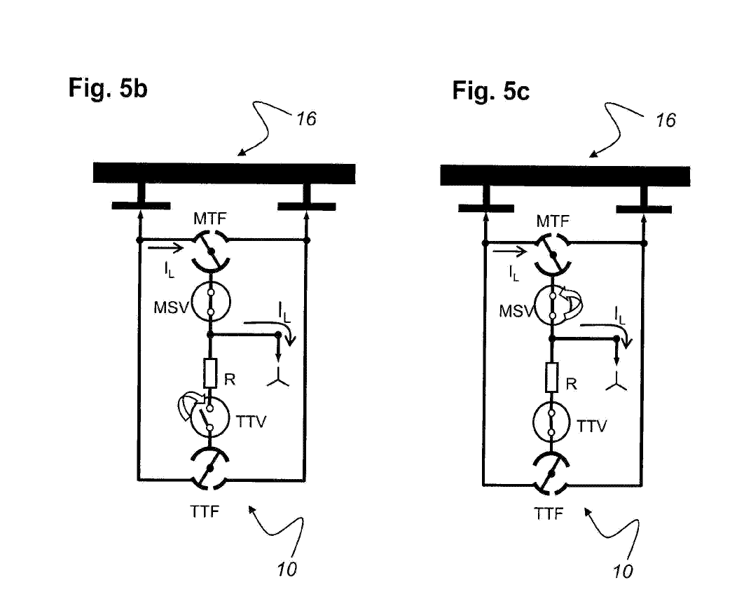

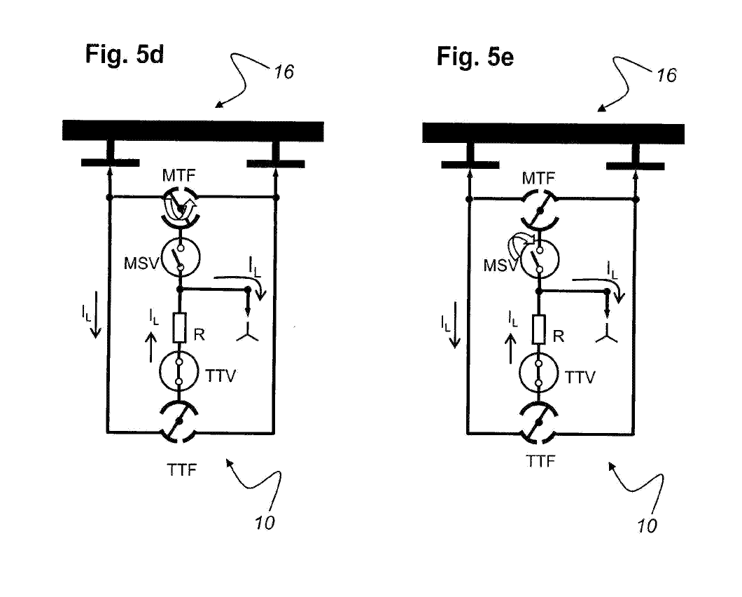

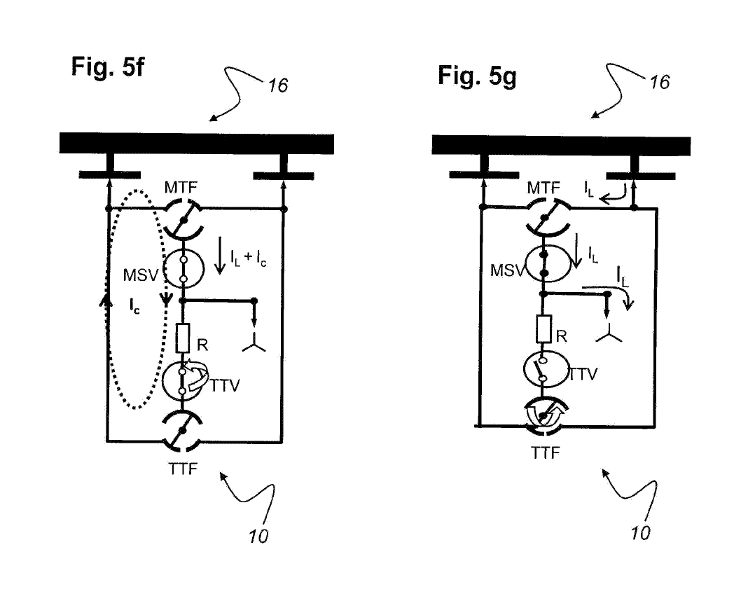

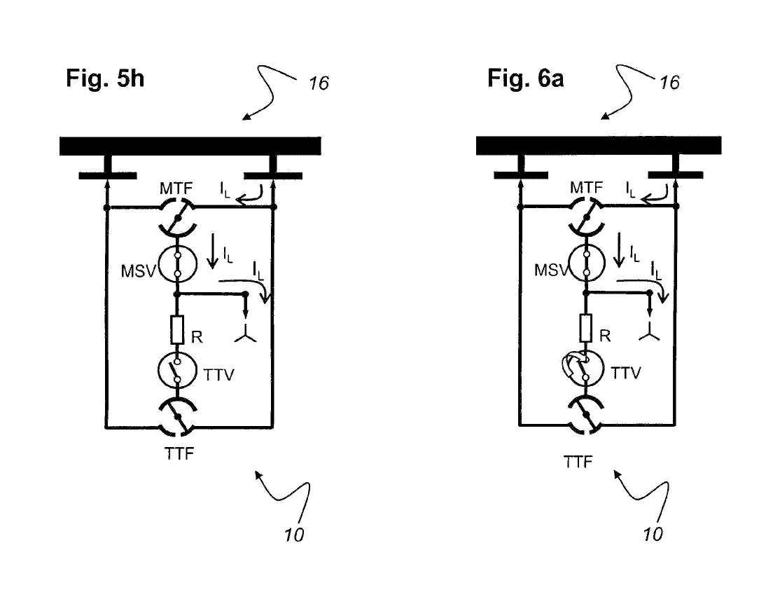

FIG. 5 shows, in several circuit diagrams, the individual successive switching states of the different components of the tap changer in a first switching direction,

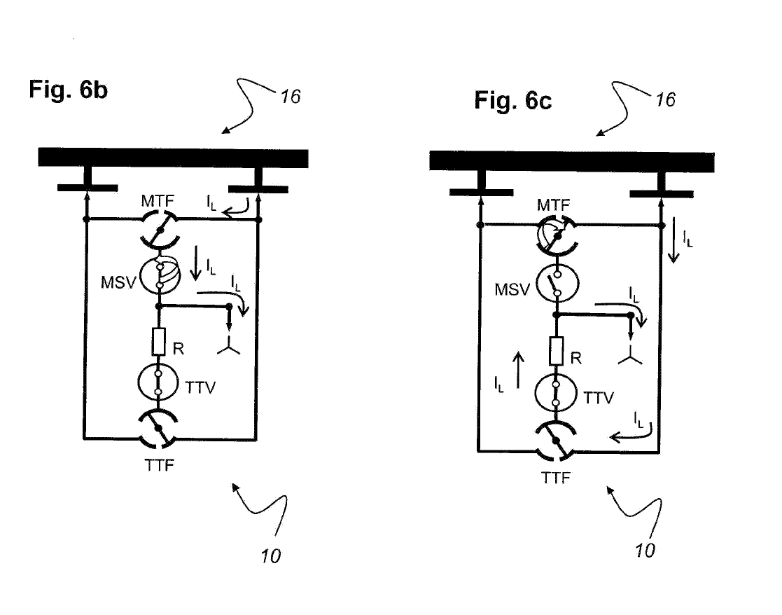

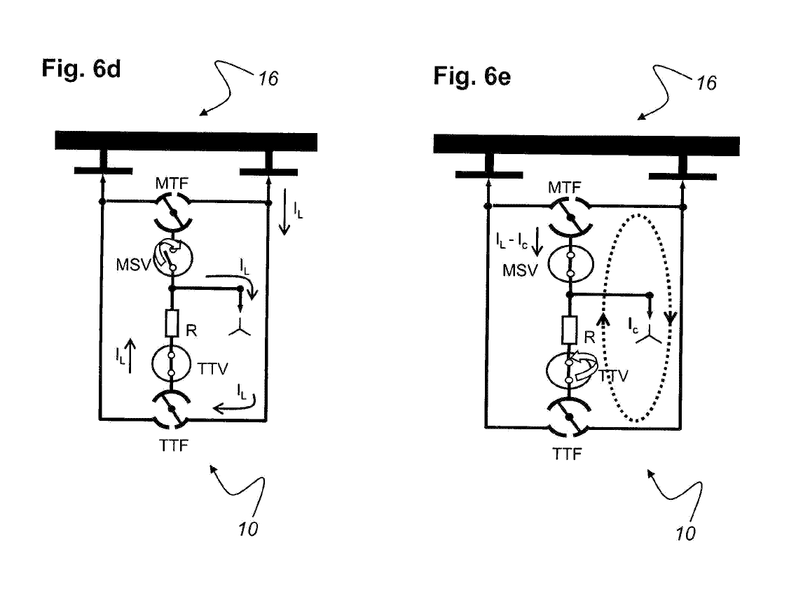

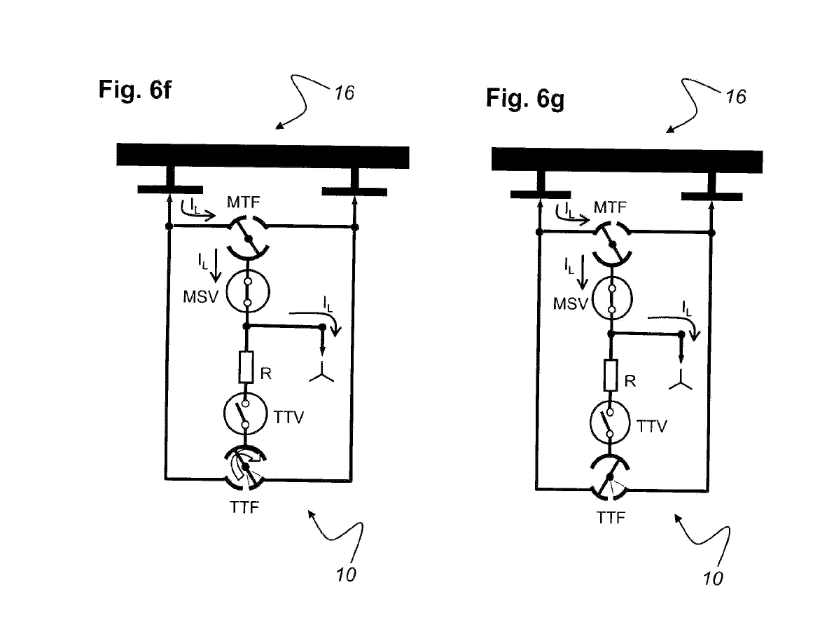

FIG. 6 shows, in several circuit diagrams, the individual successive switching states of the different components of the tap changer in a second switching direction and

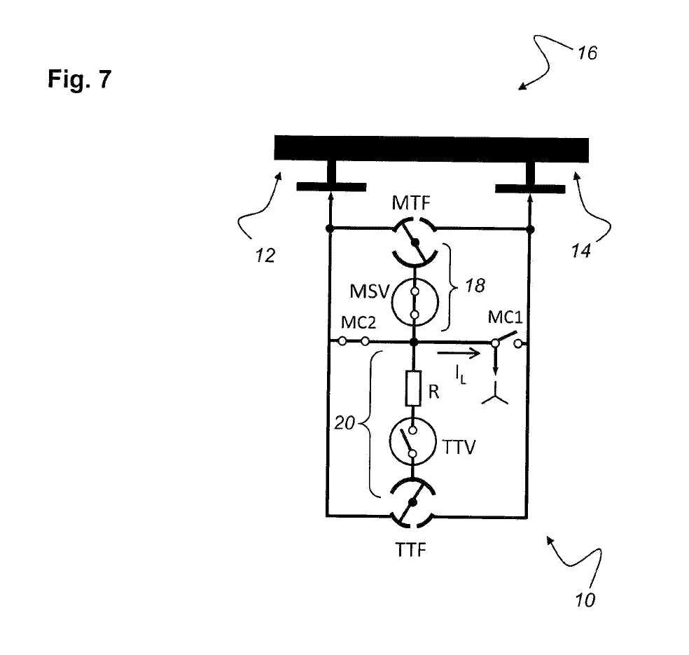

FIG. 7 shows, on the basis of a further circuit diagram, a variant of a tap changer supplemented by two additional permanent main contacts.

The embodiment described in the following is not to be understood as limiting, but serves for explanation of the function and the switching possibilities of a tap changer according to the invention.

The schematic perspective illustrations of FIGS. 1 and 2 show an embodiment of a tap changer 10, comprising a switching shaft 22 with actuating elements 24 arranged thereat and switching elements 26 coupled therewith. The schematic illustration of FIG. 3 additionally shows an inverted plan view of the tap changer 10 according to FIG. 1. As will be clarified on the basis of FIGS. 4 to 7 to be explained in the following, a delayed switching or triggering instant of one of two mechanical switching elements TTF has a defined spacing in time from the remaining switching or triggering instants of a first mechanical switching element MTF and two vacuum switching tubes MSV and TTV. In addition, the mechanical switching element TT having a switching or triggering instant delayed in time is arranged downstream of all switching elements and vacuum switching tubes regardless of the switching direction, i.e. the direction of rotation of the switching shaft 22.

The variant of embodiment, which is shown in FIGS. 1 to 3, of the tap changer 10 according to the invention provides a switching shaft 22 that is rotatable about its axis in both directions and with which four parallelly arranged, disk-shaped actuating elements 24 for each actuating phase for the mechanical switching elements 26 or vacuum switching tubes are associated, wherein the actuating elements 24 are respectively formed by concentric cam disks 28, which are rotatable by the switching shaft, with profiles or projections 30 at the circumference. Such profiles and/or projections could selectably also be arranged at the end face of the cam disks. These projections 30 trigger the respective switching elements 26 or vacuum switching tubes in the switch block 27 in that they are rotated into the outline of the switch block 27 and past, in which case they rotate or actuate the respective mechanical switching element and/or the respective vacuum switching tube through a defined switching path. As apparent in FIGS. 1, 2 and 3, each of the four cam disks 28 that are present can have at the outer circumference thereof a respective plurality of equidistantly spaced projections or lobes 30 so that a complete rotation of the switching shaft 22 through 360 degrees is not required for a complete switching cycle of the tap changer, but rather, for example, a 120 degree rotation can be sufficient for that purpose. In addition, the outer profiles of the projections or lobes 30 of the cam disks 28 and a special mechanism of the mounting of at least one of the cam disks 28 make it possible for the switching instant, which is triggered by the at least one cam disk 28 corresponding with the mechanical switching element TTF to be switched with a delay in time, to be delayed in time relative to the rotational movements of the other cam disks 28 or of the other actuating elements 24 independently of the rotational direction of the at least one cam disk or of the rotational direction of the switching shaft 22.

The switching or triggering, which is delayed in each switching direction, of the second mechanical element TTF (FIGS. 5 and 6), which is denoted in FIGS. 1 and 3 by the reference numeral 32, is realized in the illustrated tap changer 10 in that a freewheel 34 for phase displacement of the switching instant depending on the respective direction of rotation of the switching shaft 22 is associated with the relevant switching means or actuating element 24 and the cam disk 28 associated therewith. This freewheel 34 is formed as a guide gate 36, which is of circularly segmental shape and arranged concentrically with respect to the switching shaft 22, for a circularly annular entrainer of the corresponding cam disk 28 as well as a sleeve-like separating element 38, which is fixed relative to the rotatable switching shaft 22 and the cam disk 28 guided thereon by means of an arm 40 located to be fixed relative to the housing and that decouples the rotational movements of the switching shaft 22 and the cam disk 28 mounted thereon from one another. The separating element 38 ensures in a simple and effective manner that the cam disk 28 on rotation of the switching shaft 22 does not uncontrollably rotate therewith, for example due to viscous effects of the oil bath in which the components of the tap changer 10 are arranged or dip into, but that the cam disk 22 is rotated exclusively by the co-operating entrainer elements and guide gates 36. These cooperating entrainer elements and guide gates 36 define, through the dimensions and arrangements thereof, the hysteresis of the freewheel 34, i.e. the switching delay that in each rotational direction of the switching shaft 22 has a spacing in time of exactly the same amount from the start of switching. Thus, the general idea of the invention of guaranteeing a desired surge voltage strength or aO strength by respective delayed switching of the mechanical switching element 32 or TTF at one of several load branches regardless of the respective switching direction of the switching shaft 22 is clearly illustrated by FIGS. 1 to 3. In this manner, surge voltages that possibly occur do not load the vacuum switching tubes in the respective load branch not conducting load current and thus remain harmless to the vacuum switching tubes.

The illustration of FIG. 4 shows a sequence diagram, which is to be understood as exemplifying and qualitative, for clarification of the switching sequences of an embodiment of the tap changer 10 according to the invention (cf FIGS. 1 to 3) during a switching cycle in respectively different switching directions. The upper diagram illustrates the switching sequence of a tap changer, which consists, in total, of four individual switching units, in a first switching direction, whilst the lower diagram shows the switching sequence in the opposite switching direction. The schematic illustrations of FIG. 5 (FIGS. 5a to 5h) show, in total, nine circuit diagrams of the individual successive switching states of the different components of the tap changer in a first switching direction, which in FIG. 5a is characterized by the switching direction n n+1.

The tap changer 10 illustrated in FIG. 5 on the basis of the circuit diagram serves for uninterrupted switching over between two winding taps 12 and 14 of a tapped transformer 16. The tap changer 10 forms a load branch with two parallel paths 18 and 20. Each of these paths 18 and 20 comprises a respective series arrangement of a vacuum switching tube MSV. TTV and a mechanical switching element MTF. TTF, which in the present context can also be termed variably settable or switchable-over switching contact. The first path 18 is formed by the first vacuum tube MSV, connected in series, and the first mechanical switching element MTF. The second path 20 is formed by a series circuit of the second vacuum switching tube TTV, the second mechanical switching element TTF and a resistance R. Through switching-over of the two mechanical switching elements MTF and TTF and through opening and closing the two vacuum switching tubes, the two winding taps 12 and 14 of the tapped transformer can be variably coupled together and/or loaded by a load shunt LA.

The two vacuum switching tubes MSV and TTV and the two mechanical switching elements MTF and TTF are, according to FIG. 4, switchable with a defined offset in time relative to one another in respectively different switching directions (n→n+1 or n+1→n). As can already be seen by way of FIG. 4, the second mechanical switching element TTF has a switching or triggering instant delayed relative to the first switching element MTF and the two vacuum switching tubes MSV and TTV as well as independent of the switching direction, whereby defined switching states can be realized in a simple, reliable and precisely reproducible manner with the help of mechanical means. In addition, the second mechanical switching element TTF having a switching or triggering instant delayed in time is arranged downstream of all other switching elements and vacuum tubes.

The diagram of FIG. 4 shows the sequences in a complete switching process, beginning from the instant zero at the top for a drive direction from the left to the right (n→n+1), i.e. ending at a definable instant (cf FIG. 5), and at the bottom for a drive direction from the right to the left (n+1→n), i.e. beginning at a definable instant corresponding with the lower scale and ending entirely at the right at zero. The switching setting of the tap changer 10 at the start of switching is illustrated in FIG. 5a. The first vacuum switching tube MSV is in that case closed, whilst the switching contact of the second vacuum switching tube TTV is open. The first mechanical switching element MTF is disposed in a first switch setting in which the load current k from the first winding tap 12 of the tapped transformer 16 can flow by way of the first mechanical switching element MTF and the closed first vacuum switching tube MSV to the load shunt LA.

After a short time the second vacuum switching tube TTV is closed (cf FIG. 5b), whereafter the first vacuum switching tube MSV is opened (cf FIG. 5c). This opening after a short time after the start of switching is illustrated in FIG. 5b. In this switching state of the tap changer 10 with the opened first vacuum switching tube MSV and the closed second vacuum switching tube TTV and in the first switching setting, which is shown in FIGS. 5a to 5g, of the second mechanical switching element TTF the load current IL flows in the manner, which is shown in FIGS. 5d and 5e, from the first winding tap 12 of the tapped transformer 16 through the second load branch or the second path 20, which can also be termed resistance path or R-branch, to the load shunt LA.

After a further short time the first mechanical switching element MTF is switched over (FIG. 5d, FIG. 5e), whereby the closing of the first vacuum switching tube MSV (FIG. 5e, FIG. 5f) and the subsequent opening of the second vacuum switching tube (TTV (FIG. 5f, FIG. 5g) is prepared. The load current IL flows in the manner, which is shown in FIG. 5g, from the second winding tap 14 of the tapped transformer 16 through the correspondingly switched first mechanical switching element MTF and the closed first vacuum switching tube MSV to the load shunt LA. Finally, in this illustrated switching cycle the second mechanical switching element TTF is again switched over to the second winding tap 14 (FIG. 5g, FIG. 5h), whereby the switching cycle is concluded.

On the basis of the illustration of the individual switching processes of the switching cycle (n→n+1; FIG. 4 at the top) illustrated in FIG. 5 it is clear that the second mechanical switching element TTF is finally switched over in the explained manner. Since in accordance with the present invention this is to be the case even in the opposite switching direction, suitable precautions are taken in order to let the second mechanical switching element TTF finally switch again in the case of other components MTF. MSV and TTF otherwise switching in the reverse sequence. This delayed switching is, in accordance with the present invention, ensured by means of a freewheel to be configured in suitable manner, as was already illustratively made clear on the basis of FIGS. 1 to 3.

The illustrations of FIG. 6 show in several circuit diagrams the individual successive switching states of the different components of the tap changer in a second switching direction. Thus, the lower diagram of FIG. 4 shows the sequences in the case of a complete return switching process, for a drive direction from the right to the left (n+1→n), i.e. beginning at an instant corresponding with the lower scale and ending entirely at the left at zero. The switch setting of the tap changer 10 at the start of switching within a first time period is illustrated in FIG. 6a. The first vacuum switching tube MSV is in that regard closed, whilst the switch contact of the second vacuum switching tube TTV is opened. The first mechanical switching element MTF is disposed in its second switch setting, in which the load current IL can flow from the second winding tap 14 of the tapped transformer 16 via the first mechanical switching element MTF and the closed first vacuum switching tube MSV to the load shunt LA. This is at the same time the switching setting corresponding with FIG. 5h, at which the first switching cycle corresponding with the upper diagram of FIG. 4 was concluded.

The invention in this regard provides that the second mechanical switching element TTF is switched over not at an early instant, but initially remains in the second switching setting, which is shown in FIG. 6a (as well as in FIGS. 6b to 6f) and which in the case of the return switching process corresponding with FIG. 6 is to be realized merely in that the switching movement of the second mechanical switching element TTF is at least partly decoupled from the switching movements of the rest of the switching elements or vacuum switching tubes, which takes place by means of the freewheel corresponding with FIGS. 1 to 3.

After a definable time, the second vacuum switching tube TTV is closed (cf FIG. 6a), whereafter the first vacuum switching tube MSV is opened (cf FIG. 6b). This opening of the first vacuum switching tube MSV takes place within a definable time period after the start of switching, which is illustrated in FIG. 6b (open) and FIG. 6c (MSV opened). In this switching state of the tap changer 10 with the opened first vacuum switching tube MSV and the closed second vacuum switching tube TTV and in the case of the second switching setting, which is shown in FIGS. 6a to 6f, of the second mechanical switching element TTF the load current IL flows in the manner, which is shown in FIGS. 6c and 6d, from the first winding tap 12 of the tapped transformer 16 through the second load branch or second path 20, which can also be termed resistance path or R-branch, to the load shunt LA.

After a further short period of time the first mechanical switching element MTF is switched over (FIG. 6c, FIG. 6d), whereby the closing of the first vacuum switching tube MSV (FIG. 6d, FIG. 6e) and the subsequent opening of the second vacuum switching tube TTV (FIG. 6e, FIG. 6f) is prepared. The load current IL thus again flows in the manner shown in FIG. 6f from the first winding tap 12 of the tapped transformer 16 through the correspondingly switched first mechanical switching element MTF in the closed first vacuum switching tube MSV to the load shunt LA. Finally, in this illustrated return switching cycle the second mechanical switching element TTF is again switched over to the first winding tap 12 (FIG. 6f, FIG. 6g), whereby the switching cycle is concluded. In this manner, on the basis of the illustration of the individual switching processes of the switching cycle (n+1→n; FIG. 4 at the bottom) shown in FIG. 6 it is again clear that the second mechanical switching element TTF is finally switched over in the explained manner.

The illustrated switching delays of the second mechanical switching element TTF form a realization of the general idea of the invention of being able to realize the desired surge voltage strength or aO strength by means of a suitable freewheel in the tap changer by respectively delayed switching of the mechanical switching element TTF in one of two load branches independently of the respective switching direction. In this manner, surge voltages, which possibly arise, do not load the vacuum switching tubes MSV and TTV in the respective load branch not conducting load current and thus remain without harm to the vacuum switching tubes. The illustration of FIG. 7 shows, on the basis of a further switching diagram, a variant of a tap changer 10 supplemented by two additional switches or permanent main contacts MC. In this alternative variant of the tap changer 10 mechanical contacts MC are respectively additionally provided on the side to be switched off and the side to be switched on. These permanent main contacts MC or additional switches each conduct a permanent current. In addition, they are switched so that the contact MC2 on the side to be switched off opens before all remaining switching elements (MSV, TTV, MTF, TTF) and the contact MC2 on the side to be is switched on closes after all remaining switching elements.

1. A tap changer for uninterrupted switching-over between at least two winding taps of a tapped transformer, the tap changer comprising a rotatable switching shaft, with which actuating elements for a plurality of actuation phases for mechanical switching elements or vacuum switching tubes are associated, wherein associated with the actuating elements are respective concentric cam disks, which are rotatable by the switching shaft, with end-face or circumferential profiles, projections, lobes or the like and wherein the switching instants triggered by at least one cam disk are delayed in time relative to the rotational movements of the remaining cam disks or the remaining actuating elements independently of the rotational direction of the switching shaft.

2. The tap changer according to claim 1, wherein a freewheel for phase displacement of the switching instant depending on the respective rotational direction of the switching shaft is associated with at least one of the switching means or actuating elements and the cam disk associated therewith.

3. The tap changer according to claim 1, wherein the freewheel comprises a guide gate, which is circularly segmental in shape and is arranged concentrically with respect to the switching shaft, for an entrainer of the cam disk as well a sleeve-shaped separating element, which is fixed to the housing to be stationary relative to the rotatable switching shaft and the cam disks and decouples the rotational movements of the switching shaft and the cam disk mounted thereon from one another.

4. The tap changer according to claim 1, wherein a load branch with at least two parallel paths, which each comprise a series arrangement of at least one vacuum switching tube and at least one mechanical switching element, is provided, wherein a resistance and arranged in series with the respective vacuum switching tube and mechanical switching element is associated with at least one path, wherein the at least two winding taps can be variably coupled together and/or loaded by a load shunt, wherein the, in total, at least two vacuum switching tubes and at least two mechanical switching elements are switchable in common with a defined offset in time with respect to one another in respectively different switching directions and wherein at least one of the mechanical switching elements has a switching or trigger instant delayed in time relative to the remaining switching elements or vacuum switching tubes and independent of the switching direction.

5. The tap changer according to claim 4, wherein the delayed switching or trigger instant has a defined spacing in time from the remaining switching or trigger instants of the further mechanical switching elements and vacuum switching tubes.

6. The tap changer according to claim 4, wherein the mechanical switching element having a switching or trigger instant delayed in time is arranged downstream of all remaining switching elements and vacuum switching tubes.

7. The tap changer according to claims 1, wherein a respective mechanical contact is additionally present on the switching-off and switching-on side and conducts a permanent current, of which the contact on the switching-off side opens before all remaining switching elements and the contact on the switching-off side closes after all remaining switching elements.
